(19) United States
(12) Patent Application Publication
(10) Pub. No.: US 2015/0127695 A1
(43) Pub. Date: May 7, 2015

(54) PROCESSOR TRIGONOMETRIC COMPUTATION

(71) Applicant: Texas Instruments Incorporated, Dallas, TX (US)

(72) Inventors: Kyong Ho Lee, Plano, TX (US); Seok-Jun Lee, Allen, TX (US); Manish Goel, Plano, TX (US)

(73) Assignee: Texas Instruments Incorporated, Dallas, TX (US)

(21) Appl. No.: 14/072,378

(22) Filed: Nov. 5, 2013

(51) Int. Cl. G06F 1/02

(52) U.S. Cl. CPC G06F 1/02
USPC 708/276

(57) ABSTRACT

A method for a processor computing a first trigonometric function to use an alternative trigonometric function for certain ranges of the operand. A modulo function may be used to provide an operand with a reduced range, and the modulo function may subtract in multiple steps in a manner that preserves low-order bits.

### BACKGROUND

Microprocessors and microcontrollers often need to compute various math functions, for example trigonometric functions such as sine and cosine. One common method is to use a Taylor series in which a math function is approximated by a polynomial. In general, when a polynomial Pₙ(x) is used to approximate a function f(x) there is some inherent error when the polynomial is truncated at xⁿ, even for computation with infinite precision. Using processors with finite precision increases the error as low-order bits are lost during computation. The error can be reduced by increasing the number of bits used to represent each quantity. However, in general, increasing the number of bits increases gate count, increases power consumption, and may increase computation time. There is an ongoing need for increased precision in computation of math functions, particularly for low-gate-count ultra-low-power applications.

### BRIEF DESCRIPTION OF THE DRAWINGS

FIG. 1A is a graph of a trigonometric function (cos(x)) illustrating error in a polynomial approximation of the trigonometric function.

FIG. 1B is a graph of a trigonometric function (sin(x)) illustrating error in a polynomial approximation of the trigonometric function.

FIG. 2 is a flow chart of an example embodiment of a method of computing a trigonometric function.

FIG. 3 is a block diagram schematic of an example embodiment of a processor system.

### DETAILED DESCRIPTION

The following equations are Taylor series approximations of cos(x) and sin(x), where x is in radians.

$$cos ( x ) \approx {\sum }_{n = 0}^{∞} \frac{- {1}^{n}}{( 2 n ) !} {x}^{2 n} = 1 - \frac{{x}^{2}}{2 !} + \frac{{x}^{4}}{4 !} - …$$

$$sin ( x ) \approx {\sum }_{n = 0}^{∞} \frac{- {1}^{n}}{( 2 n + 1 ) !} {x}^{2 n + 1} = x - \frac{{x}^{3}}{3 !} + \frac{{x}^{5}}{5 !} - …$$

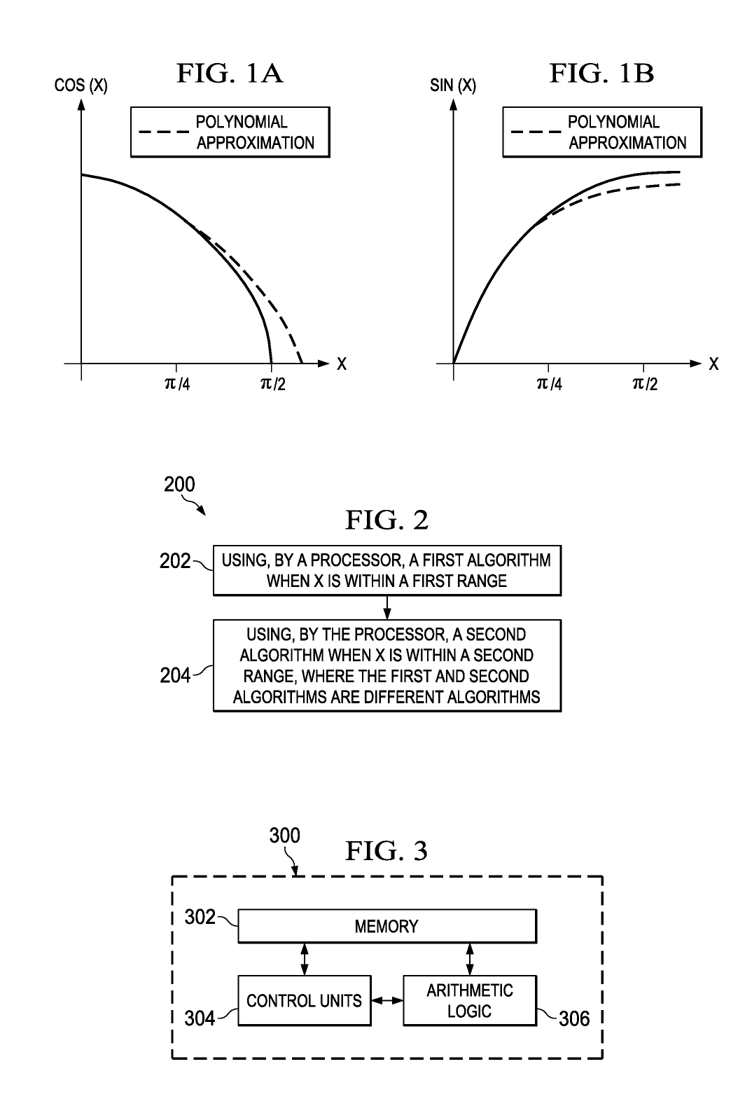

In FIG. 1A, the solid line illustrates an exact curve for cos(x) (where x is in radians) and the dashed line illustrates a Taylor series approximation of cos(x) (with the error exaggerated to facilitate illustration). FIG. 1B illustrates an exact curve for sin(x) (solid line) and a Taylor series approximation of sin(x) (dashed line). In each of FIGS. 1A and 1B, the Taylor series is accurate at x=0 and some inherent error occurs as x increases. In particular, the error for cos(x) peaks around x=π/2 radians where cos(x) approaches zero.

Since the accuracy of a Taylor series is best when x=0, the accuracy of a Taylor series for cos(x) can be improved by shifting the origin of the series, depending on the value of x, and using the appropriate trigonometric function for the shifted origin. For example, cos(x)=sin (π/2−x), and for some ranges of x, the accuracy of a Taylor series for sin (π/2−x) may be better than the accuracy for a Taylor series for cos(x). In particular, the accuracy of a Taylor series for cos(x) can be improved by using the Taylor series for sin(π/2−x) when x is between π/4 and π/2. Likewise, the Taylor series accuracy for cos(x) can be improved by using the Taylor series for −sin(x−π/2) when x is between π/2 and π3π/4, and so forth. The table below details which trigonometric function (as implemented by a Taylor series approximation) has the least error for a range of x from x=0 to x=2π.

| | Taylor |
|---|---|
| x | series |
| 0 − π/4 | cos(x) |
| π/4 − π/2 | sin(π/2 − x) |
| π/2 − 3π/4 | −sin(x − π/2) |
| 3π/4 − π | −cos(π − x) |
| π − 5π/4 | −cos(x − π) |
| 5π/4 − 3π/2 | −sin(3π/2 − x) |
| 3π/2 − 7π/4 | sin(x − 3π/2) |
| 7π/4 − 2π | cos(x − 7π/4) |

Note that it is not necessary to switch algorithms at exact multiples of π/4. The Taylor series may be sufficiently accurate to use sin(x) beyond x=pi/4 and the boundaries and ranges in the table are just examples of convenient boundaries.

In general, the value of x may be greater than 2 π. If x is greater than 2 π, then the operand may be brought within a range of zero to 2 π by using (x modulo 2 π) as the operand instead of x. Given an operand within the range of zero to 2 π, the proper choice of which trigonometric function to use may be determined by using the integer value of operand/(π/4) as an index for the above table.

In conventional algorithms for the modulo function, (a mod n) is computed as, for example, (a−n*int(a/n). Conventional algorithms for a modulo function may be inaccurate when the dividend is large because low-order bits are lost due to shifting and rounding. A more accurate modulo algorithm is provided below.

Assume that a processor needs to calculate (x mod 2 π):

1. Let quotient=int(x/(2 π))

2. Divide the digits of π into multiple parts as follows:

| | | | |
|---|---|---|---|
| π = | 3.141592 | 6535897 | 9323846 |

3. Let op1=3.141592

4. Let op2=6.53589710⁻⁷

5. Let op3=9.323846*10⁻¹⁴

6. Compute (x mod 2 π)=((x/2−quotient*op1)−quotient*op2))−quotient*op3

That is, the improved modulo function subtracts in multiple steps that retain the lower order bits of the remainder. In particular, each of op1, op2, op3 may be single-precision numbers and the improved modulo function enables a calculation with single-precision that is more accurate than a conventional algorithm using double-precision.

The above discussion uses computation of cos(x) as an example, but the principle of using an alternate trigonometric function that is more accurate for a range of x is equally applicable to sin(x). For example, when x is between π/4 and π/2, a processor may compute cos(π/2−x) instead of sin(x).

FIG. 2 is a flow chart illustrating an example embodiment of a method 200 of computing a trigonometric function for an operand x. At step 202, a processor uses a first algorithm when x is within a first range. At step 204, the processor uses a second algorithm when x is within a second range, where the first and second algorithms are different algorithms.

FIG. 3 illustrates an example embodiment of a processor 300. The processor 300 includes memory 302, a control unit 304, and arithmetic logic 306. The processor 300 may be programmed to use the arithmetic logic 306 to compute a trigonometric function in accordance with the method of FIG. 2.

In summary, by using alternative trigonometric functions depending on the value of the operand, and by using the improved modulo function, the methods described above can achieve better accuracy using single-precision computation than conventional methods using double-precision computation. As a result, a processor can have lower complexity and lower energy and computation of trigonometric functions may be faster.

What is claimed is:

1. A method for computing a trigonometric function for an operand x, comprising:
using, by a processor, a first algorithm when x is within a first range; and
using, by the processor, a second algorithm when x is within a second range,
where the first and second algorithms are different algorithms.

2. The method of claim 1, where the first range is between 0 and about π/4 radians and the second range is between about π/4 and about π/2 radians.

3. The method of claim 1, where the operand for the first algorithm is x and the operand for the second algorithm is (π/2−x).

4. The method of claim 1 where the first algorithm computes cosine(x) and the second algorithm computes sine(π/2−x).

5. The method of claim 1 where the first algorithm computes sine(x) and the second algorithm computes cosine(π/2−x).

6. The method of claim 1 where the first algorithm is a Taylor series polynomial.

7. The method of claim 1, further comprising:
using, by the processor, (x modulo 2 π) for x when x is greater than 2 π radians.

8. The method of claim 7, further comprising:
computing (x modulo 2 π) in a series of steps, where each successive step uses a lower order group of bits of π.

9. A processor, comprising:
arithmetic logic for computing arithmetic functions, the processor programmed to control the arithmetic logic to compute a trigonometric function for an operand x using the following steps:
using, by the processor, a first algorithm when x is within a first range; and
using, by the processor, a second algorithm when x is within a second range, where the first and second algorithms are different algorithms.

10. The processor of claim 9, where the first range is between 0 and about π/4 radians and the second range is between about π/4 and about π/2 radians.

11. The processor of claim 9, the processor further programmed such that the first algorithm computes cosine(x) and the second algorithm computes sine(π/2−x).

12. The processor of claim 9, the processor further programmed such that the first algorithm computes sine(x) and the second algorithm computes cosine(π/2−x).

13. The processor of claim 9, the processor further programmed to use (x modulo 2 π) for x when x is greater than 2 π radians.

14. The processor of claim 9, the processor further programmed to compute (x modulo 2 π) in a series of steps, where each successive step uses a lower order group of bits of π.
